(19) United States
(12) Patent Application Publication
(10) Pub. No.: US 2013/0323696 A1
(43) Pub. Date: Dec. 5, 2013

(54) System and Method for Task-Based Training Assignment for Training on Clinical Trials

(71) Applicant: Alden MEIER, Woodland Hills, CA (US)

(72) Inventor: Alden MEIER, Woodland Hills, CA (US)

(21) Appl. No.: 13/902,713

(22) Filed: May 24, 2013

Related U.S. Application Data
(60) Provisional application No. 61/654,915, filed on Jun. 3, 2012.

(51) Int. Cl. G09B 19/00

(52) U.S. Cl. CPC G09B 19/00
USPC 434/219

(57) ABSTRACT

The invention provides a method and system for efficiently apportioning, delivering and monitoring training to clinical trial participants. The invention ensures that each person participating in a given clinical trial receives only the training that they actually need in order to perform their assigned tasks on the trial. The invention reduces the amount of unnecessary training typically taken by staff working on a clinical trial, accelerates the startup of the trial and ensures that staff receives the necessary training for the specific tasks they are performing on the trial.

### RELATED APPLICATIONS

This application, attorney docket TRI010, is related to and claims priority from provisional application 61/654,915, of the same title and by the same inventor, filed Jun. 3, 2012, the entirety of which is incorporated by reference as if fully set forth herein.

### GOVERNMENT FUNDING

None

### FIELD OF USE

The invention is useful in the field of preparing for and running clinical trials, and in particular in optimizing training of personnel involved in conducting clinical trials.

### BACKGROUND

Biomedical or health-related clinical trials require qualified and trained site personnel that perform the various tasks required to successfully conduct the trial. Sponsor organizations, along with the principal investigators at individual sites are responsible for ensuring that all personnel who participate in clinical trials have the necessary qualifications and have been adequately trained for the specific duties that they will perform during the trial. This training includes general training that is required for all clinical trials such as Good Clinical Practices and protocol specific training that is unique to each trial.

Online, Internet delivered training has become commonplace for clinical trials, replacing or augmenting in-person training. Online training provides the opportunity to quickly and efficiently deliver the necessary training to all of the investigators and site personnel. However, on-line training also introduces different challenges from in-person meetings. One significant challenge is delivering the correct training to each investigator and site personnel assigned to the trial.

There are several approaches that a Sponsor typically takes to ensure adequate training for each person. Sponsor organizations will, in some cases, require that all participants, regardless of what they will do on the trial receive the same training. Alternatively, the Sponsor may specify the training by a particular role of personnel in the trial. In other cases, the Sponsor will delegate the task of identifying training requirements for each person at a given research site to the Principal Investigator at the site.

All of the different approaches to defining training for a trial can result in overtraining for some site staff or inconsistent training between equivalent site staff across sites. In those cases where the Sponsor identifies training requirements for the various roles of personnel participating in the trial there can also be inconsistencies since not all roles perform equivalent tasks in the various regions around the world. For example, a sub-investigator in Europe may not perform the same tasks as a sub-investigator in the United States. These factors can make training for clinical trials highly inefficient and difficult to monitor, as well as frequently resulting in inconsistent training for personnel participating in the trial.

What is needed is a method of ensuring that each person participating in a given clinical trial receives only the training that they actually need in order to perform their assigned tasks on the trial. This will reduce the amount of unnecessary training being taken by staff working on a clinical trial, accelerate the startup of the trial and ensure that staff receives the necessary training for the specific tasks they are performing on the trial.

### BRIEF SUMMARY OF THE INVENTION

The invention provides a solution to at least all of the aforementioned unmet needs. The invention provides a method and system for efficiently apportioning, delivering and monitoring training to clinical trial participants. The invention ensures that each person participating in a given clinical trial receives only the training that they actually need in order to perform their assigned tasks on the trial. The invention reduces the amount of unnecessary training typically taken by staff working on a clinical trial, accelerates the startup of the trial and ensures that staff receives the necessary training for the specific tasks they are performing on the trial.

The invention, herein referred to as “Task Based Training”, is a system and method that allows discrete work tasks that are performed on clinical trials to be identified and entered into a database by an authorized administrator. The tasks are then associated with the training curriculum that users who perform those specific tasks must take in order to participate in the trial. The association of the tasks with the training curriculum then enables monitoring the training of each user according to the tasks that user has been assigned to perform in the course of conducting the clinical trial. Each user need only be required to take the training for the specific tasks they will perform on the trial, thus eliminating any unnecessary training and ensuring that the required training is actually taken.

Tasks can be the same or different across Sponsors, Therapeutic Area or geographic regions and may even be different for individual trials. The system supports the creation of tasks at any level so that they can be reused across multiple trials or created to be unique to a single trial. In the future, it is possible that an electronic implementation of the Delegation of Authority form (also referred to as the Delegation of Responsibilities Log or the Delegation of Duties log) can be integrated into the system and provide the approved list of tasks for the Sponsor rather than having those tasks entered into the system separately. The Delegation of Authority form is a regulatory document that is required to be completed by the Primary Investigator at a site and lists each staff member at the site along with the authority they have been delegated in the form of tasks or responsibilities. This document is the official record of the responsibilities for each staff member for a given trial.

Some examples of specific tasks include:
a. Communicating with IRB
b. Entering data into the IVRS system
c. Retrieving expedited safety reports
d. Collecting and reporting AE/SAEs
e. Assessing AE/SAE Causality
f. Reporting Product Complaints
g. Making CRF entries/corrections/answering queries
h. Collecting study data

For each trial there is a curriculum of training that is created and delivered for the trial. The metadata for the individual training modules that will make up the training for the trial is created in the system by an authorized administrator using a Graphical User Interface. Some of the training modules for the trial may already exist if the training is common across all clinical trials for the Sponsor (e.g. standard regulatory training such as Good Clinical Practices). Other training modules will be created once the training curriculum for the trial has been defined.

Once the tasks and the training modules have been created, the system provides a graphical user interface to allow an authorized administrator to associate those tasks with the various individual training modules for a trial. An alternate embodiment enables training modules to be associated with tasks using metadata associated with both the training module and the task, consequently reducing or eliminating the need to individually and manually associate training modules to specific tasks.

Once all of the tasks and training modules have been created, the system provides a graphical user interface that allows the Principal Investigator at a site to select a user or multiple users at their site and identify the tasks that the user or group of users will be performing on a specific clinical trial. The system allows the Principal Investigator to select the tasks from a list of tasks that the user or users will perform. In an alternative embodiment, the users themselves are notified and are required to select the tasks that they will perform on the trial. In this embodiment, the Principal Investigator is notified via email when the user has selected their tasks and must still review and sign off on the tasks that each user has identified to ensure that the tasks are correct.

Once the Principal Investigator has finished identifying the tasks, he/she confirms that the list is complete and electronically signs to confirm their agreement with the information. If the user themselves have identified their tasks, the Principal Investigator reviews and approves the tasks as specified or makes any required changes and then electronically signs to confirm their approval. The system automatically creates an individual training profile for the user based on the tasks that have been identified.

The individual user is then sent their access credentials via email and can access the system to complete their training. The system displays a training Launcher page that displays all of the required training that the user must complete in order to participate in the trial based on the tasks that their Principal Investigator selected.

If the tasks for a user on a given trial change, the system allows the Principal Investigator to re-access the graphical user interface and add the new tasks that the user will be performing to their training profile or remove tasks. The Principal Investigator is required to again electronically sign the changes to the users training profile. The system then automatically adjusts the users training profile with any new training, if required and the user is automatically notified via email if there is additional training required to be completed or if uncompleted training is no longer required. If no changes to the training curriculum results from the changed training profile, then the user is not notified.

The system also provides a means for the Principal Investigator to assign individual training modules even if the user isn't required to take the specific module being assigned based on the tasks they will perform. This gives the Principal Investigator some flexibility in requiring a specific user to take a specific module should they feel that the training is either necessary or advantageous.

The system tracks all changes made to the tasks, tasks assigned to a study, training module metadata, and individual training profiles so that an accurate audit trail can be constructed. The history includes the user information for the person who made the changes and when the changes were made.

### BRIEF DESCRIPTION OF THE DRAWINGS

The eight sheets of drawings filed herewith are intended as an aid to understanding the invention.

FIG. 1 is a flow chart depicting a process according to the invention.

FIG. 2 depicts a user interface screen useful in an embodiment of the invention.

FIG. 3 depicts a user interface screen useful in an embodiment of the invention.

FIG. 4 depicts a user interface screen useful in an embodiment of the invention.

FIG. 5 depicts a user interface screen useful in an embodiment of the invention.

FIG. 6 depicts a user interface screen useful in an embodiment of the invention.

FIG. 7 depicts a user interface screen useful in an embodiment of the invention.

FIG. 8 depicts a user interface screen useful in an embodiment of the invention.

FIG. 9 is an exemplar Delegation of Authority form in an embodiment of the invention.

### DETAILED DESCRIPTION OF THE PREFERRED EMBODIMENT

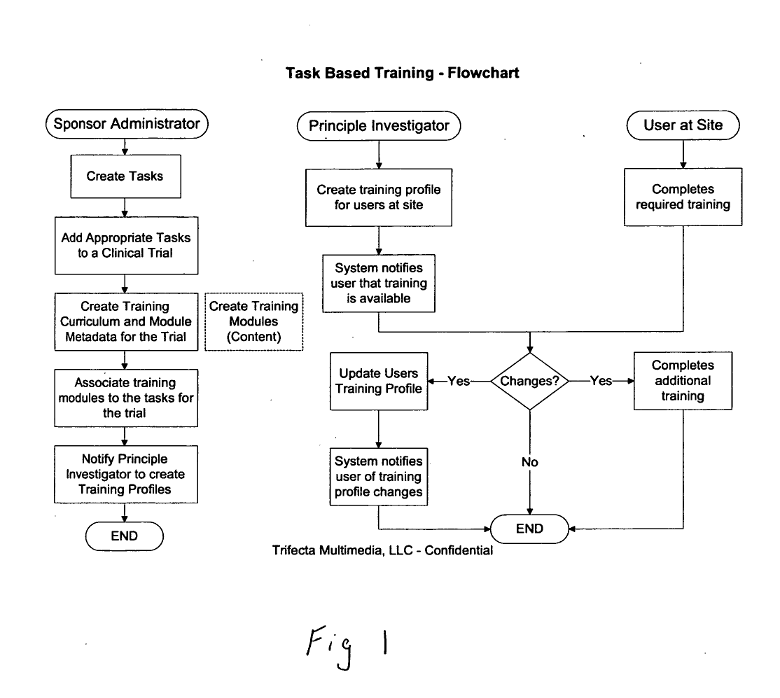

Referring to the drawing sheet bearing FIG. 1, entitled “Task Based Training Flowchart”, the inventive method comprises the steps of:

(Sponsor administrator) performing the steps of:
a. Creating tasks;
b. Adding tasks appropriate for clinical trial;
c. Creating training curriculum and module metadata for the clinical trial;
d. Associating training modules to the tasks for the clinical trial;
e. Notifying Principal Investigator to create training profiles;
(Principal Investigator) performing the steps of:
f. Creating training profile for users at site;
g. Notifying user that training is available;
(User) performing the steps of:
h. Completing training as required;
i. Updating user training profile; and,
In the event of changes in training profile, the further steps of
j. Notifying user of training profile changes;
Repeating steps h and i if additional training is completed

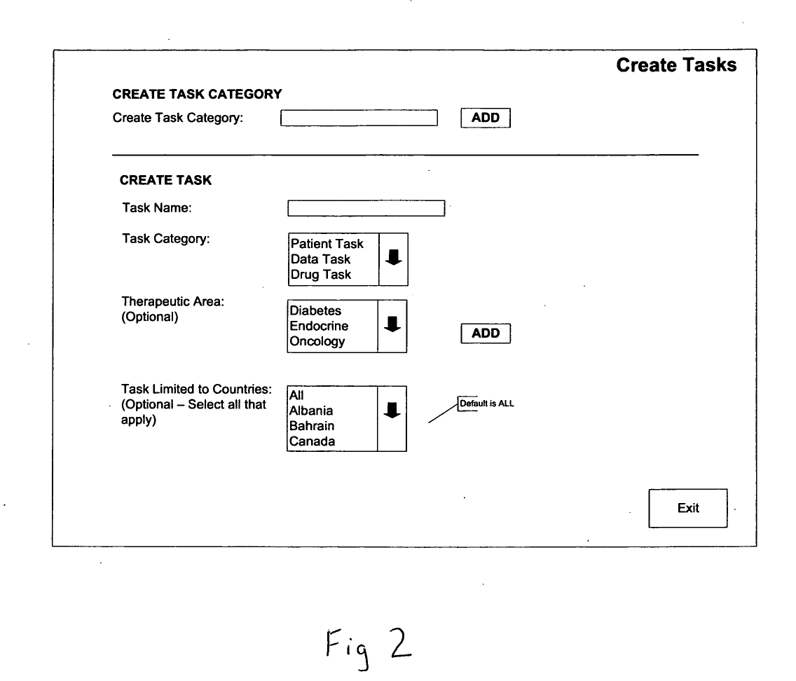

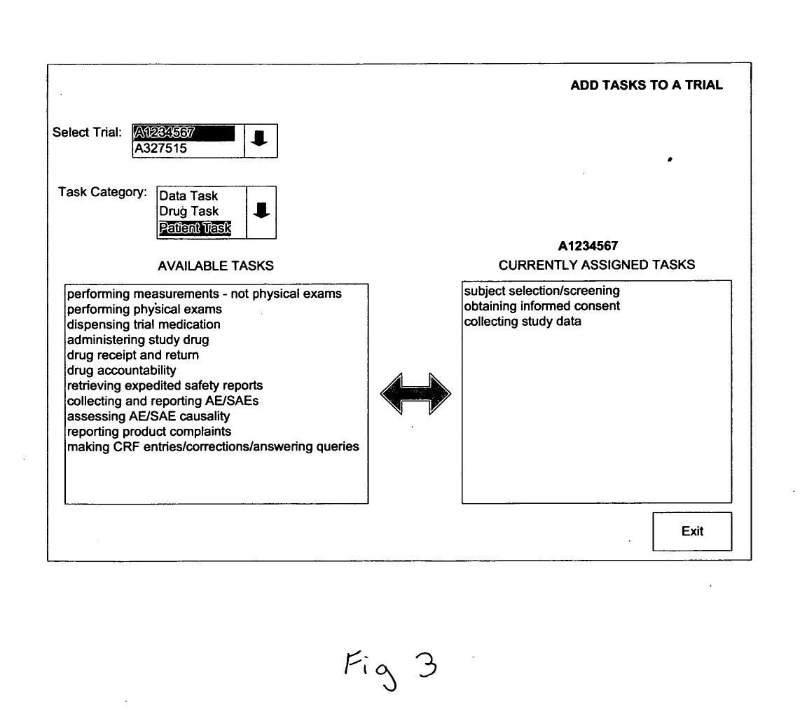

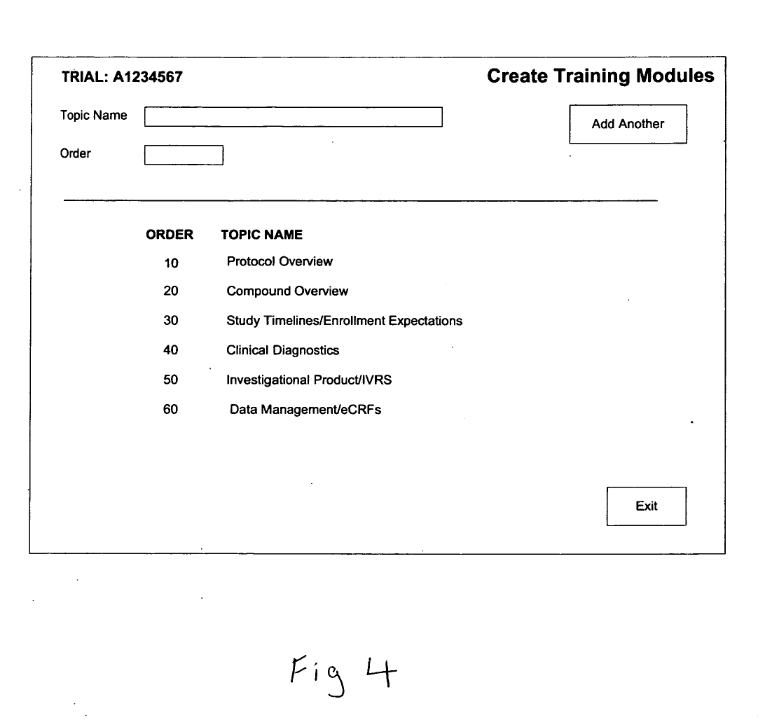

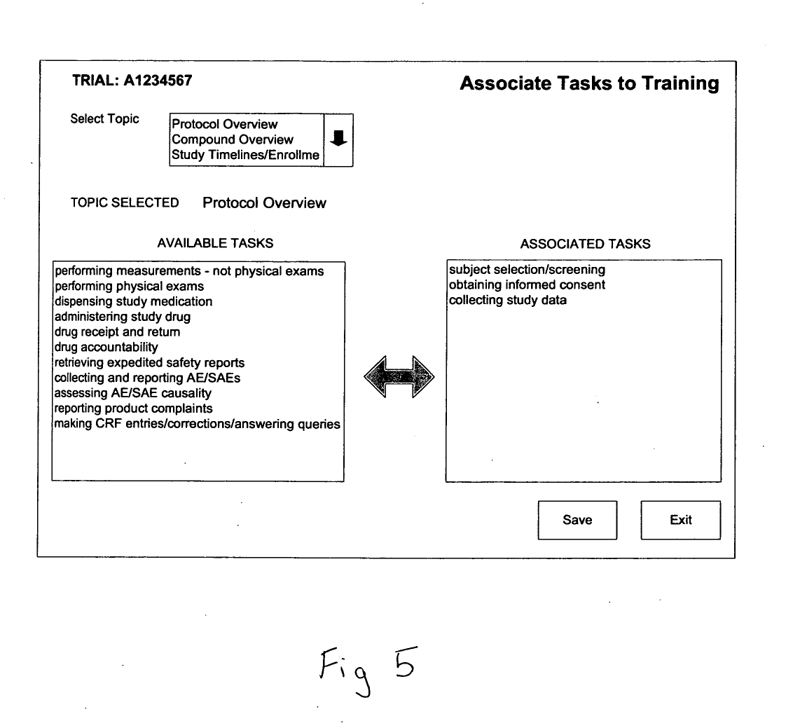

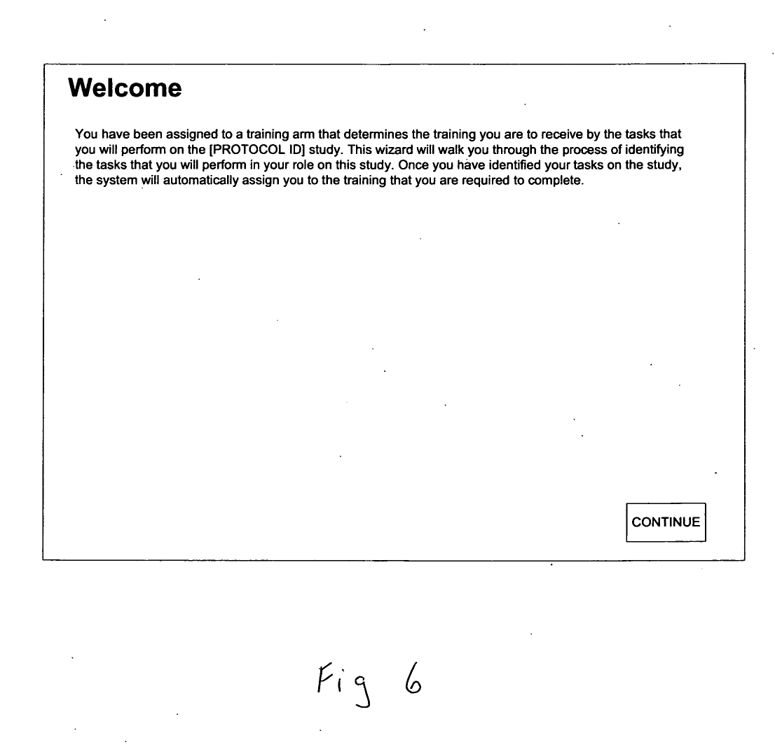

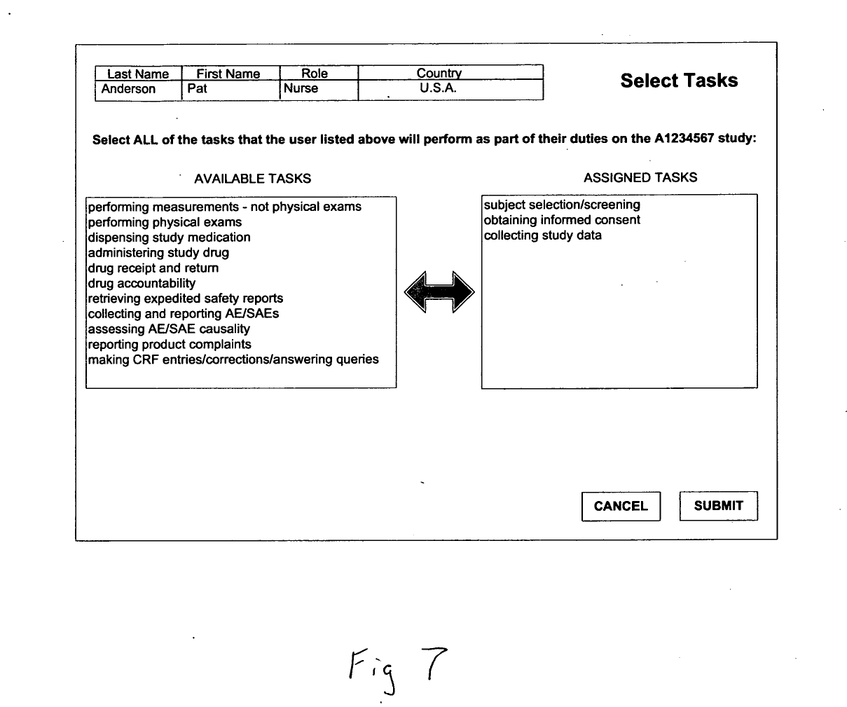

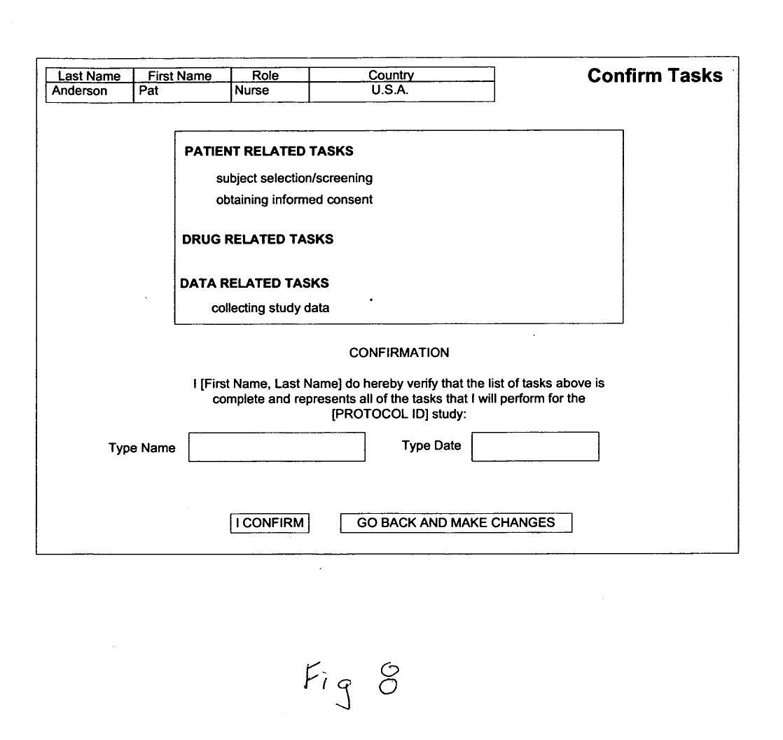

Additional drawing sheets provide exemplar screens associated with performing the steps of: creating the tasks (sheet 2, FIG. 2 labeled Create Tasks); adding tasks to the trial (sheet 3, FIG. 3 labeled Add Tasks To a Trial); creating training modules (sheet 4, FIG. 4 labeled Create Training Modules); associating tasks to a training (sheet 5, FIG. 5 labeled Associate Tasks to Training); creating training profile for users on site (sheet 6, FIG. 6 labeled Select Tasks); and confirming tasks to be performed by study staff (sheet 7, FIG. 7 labeled Confirm Tasks . It can be appreciated that the interface depicted is an illustration of how the method employs computer mediated input and output.

### SPECIFIC EXAMPLE

Applicant describes herein below an example—A Phase III randomized, double-blinded, placebo-controlled clinical trial to compare the results of drug A against drug B and a placebo arm—according to the preferred embodiment of the invention.

Once the trial has been designed, the protocol has been finalized and the sites that will conduct the trial have been selected, the Sponsor sets out to ensure that all of the personnel who will conduct the trial have been trained for all of the tasks that they will be required to perform during the trial. The Sponsor takes the decision to train their staff using an on-line system in order to expedite the training process.

The Sponsor identifies the tasks that need to be performed during the trial based on the type of trial that is being conducted. This analysis allows the Sponsor to ensure that the training is defined by the tasks that need to be performed, thereby optimizing the training to the tasks. Some of the tasks already exist in the system since they are common to multiple trials while other tasks are unique to this trial. An administrator enters those new tasks into the system. Individual tasks are assigned to a Task Group to allow tasks to be associated together in order to simplify the Graphical User Interface and make the adding of tasks to a user possible by group rather than by individual tasks.

The Sponsor then determines the individual training curriculum that is required to perform those tasks. Once the curriculum has been identified, the administrator enters the training curriculum defined for the trial. The administrator then associates each module of the training to the tasks that require that training. A single training module may be associated with one or more tasks and likewise, a task may be associated with one or more training modules.

The actual training content that will be delivered during the training is created as part of a separate process and includes presentations that have been video or audio captured as well as the supporting presentations that are simply slides that have been converted to the appropriate format from a PowerPoint presentation. The on-line training system also supports animated training, slide-only presentations and many other different types of content for use as training.

Once all of the tasks, training curriculum, and content have been loaded into the online training system, the team managing the trial creates individual training accounts for each person on the trial and sends out a notification to the Principal Investigators for each research site. The Principal Investigator logs into the system and for each person, selects that tasks that the user will perform on the trial (See Diagram). The Principal Investigator then electronically signs the training profile for the user and saves the information. An advantage of this system is that the Principal Investigator is the final arbiter of what tasks the user is going to be performing and the system automatically determines the necessary training, thus simplifying the training assignment process.

The system automatically notifies the user via email that their training is ready to be taken once their profile has been created. The user then logs into the online training system and sees the list of training that they are required to take. The user then takes their training and when they have completed, the system issues a certificate indicating that they are now ready to participate in the trial.

A few months into the trial, a Sub-Investigator at a research site is promoted to Principal Investigator. The trial management team updates the Sub-Investigators profile to indicate that she is now the Principal Investigator for her site. The new Principal Investigator then logs into the system and updates her own profile to indicate the new tasks that she will be performing on the trial. The system automatically updates her training profile to include the new training that she is required to take. She then logs into the online training system and completes the additional training she needs to perform the new tasks on the trial. The system logs her completion information and issues another certificate that includes the additional training she has taken.

The example provided herein is to aid in the understanding of the invention, and not intended as a limitation. The scope of the invention extends to cover variations not expressly recited here falling within the scope of the claims, as taught by the specification and drawings.

We claim:

1. A method of training clinical trial participants specifically for the tasks assigned to be performed in a clinical trial, said method employing at least one computing device equipped with a CPU and audio-visual display functionality, said method comprising the steps of:
creating tasks;
adding tasks appropriate for clinical trial;
creating training curriculum and module metadata for the clinical trial;
associating training modules to the tasks for the clinical trial;
notifying Principal Investigator to create training profiles;
creating training profile for users at site;
notifying user that training is available;
recording delivery and completion of required training; and
updating user training profile.

2. A method as in claim 1, further including the steps of:
updating training requirements; and
updating user training profiles.

3. A method as in claim 1 wherein the step of associating training modules to the tasks for the clinical trial is performed by a computing device programmed with instructions to sort metatags associated with said training modules and said tasks.
